(19) United States
(12) Patent Application Publication
(10) Pub. No.: US 2009/0119133 A1
(43) Pub. Date: May 7, 2009

(54) METHOD AND SYSTEM FOR POLICY UNDERWRITING AND RISK MANAGEMENT OVER A NETWORK

(76) Inventors: Luke W. Yeransian, Omaha, NE (US); Anupama V. Murthy, Omaha, NE (US)

Correspondence Address: BANNER & WITCOFF, LTD., 28 STATE STREET, 28th FLOOR, BOSTON, MA, 02109-9601, US

(21) Appl. No.: 12/262,733

(22) Filed: Oct. 31, 2008

Related U.S. Application Data
(63) Continuation-in-part of application No. 11/483,395, filed on Jul. 7, 2006.
(60) Provisional application No. 60/984,160, filed on Oct. 31, 2007.
(60) Provisional application No. 60/697,400, filed on Jul. 7, 2005.

(51) Int. Cl. G06Q 40/00

(52) U.S. Cl. 705/4

(57) ABSTRACT

A system and method for collecting insurance information, providing premium quotations, and automating policy issuance and claim processing. An embodiment utilizes automated, task-based work flow process that enables all parties to work efficiently to issue policies and handle policies.

### CROSS-REFERENCE TO RELATED APPLICATIONS

This application claim priority to commonly owned Provisional Application Ser. No. 60/984,160 filed Oct. 31, 2007, which is incorporated herein by reference. This application is also a continuation-in-part of commonly owned U.S. Utility application Ser. No. 11/483,395, filed Jul. 7, 2006, which claims priority to Provisional Application Ser. No. 60/697,400, filed Jul. 7, 2005; both of which are incorporated herein by reference.

### FIELD OF THE INVENTION

The present invention relates to data processing. More particularly, the invention relates to a system and method for collecting and processing insurance information, including automatic quotation and work flow optimization.

### BACKGROUND OF THE INVENTION

Insurance carriers may insure against personal harm, property damage, and business interruption caused by a specified peril. By way of example, such perils (or perilous events) may include a natural disaster (e.g., a tornado, a hurricane, an earthquake, a flood, etc.), a manmade disaster (e.g. a release of hazardous material from an industrial plant, a terrorist attack, arson, etc.), and the like. Before underwriting a new or renewing an existing insurance policy, an insurance carrier may receive information from an existing or prospective customer from which an evaluation may be made about the appropriateness of underwriting the policy.

When an insurance agent receives a request for an insurance policy, the agent may receive existing or prospective customer data from the policy such as: 1) the name and address of the requesting entity (e.g. an individual or a company and the address of the property to be covered); 2) the requested coverage type (e.g. life insurance or property insurance for a specified peril); 3) the desired amount of coverage, deductible, and premium; and 4) any other information that the insurance company may use in evaluating whether to underwrite the policy.

An insurance carrier may then evaluate such existing or prospective customer data to determine whether underwriting the requested insurance policy is appropriate. For example, an insurance company may consider how accepting the proposed insurance policy will affect their: 1) total revenue; 2) total exposure; 3) probable maximum loss (PML). The insurance carrier may base its evaluation on a predetermined standard, such as PML for a specified peril in a specified high risk zone not exceeding a specified PML limit.

Insurance carriers are faced with the task of systematically being required to evaluate risk presented by a particular insured's business and business activity. As with all types of insurance, this process for evaluating the risk associated with the proposed insured and their business or business activity adds to the time and cost of insurance. To obtain insurance, prospective insurance purchasers typically utilize agents that act on behalf of an insurance carrier. The insurance carrier issues insurance policies based on its comfort level with the risk posed by the information pertaining to the business or business activity. The premium charged for a particular policy is dependent upon the level of risk posed by the particular classification of insurance, in order to assess the risk and determine whether a particular risk may be insured (and the premium associated with such insurance), insurance carriers have historically used underwriters who are individuals with expertise in assessing risk based on a number of factors. These underwriters normally work in conjunction with insurance agents to collect data representing the factors which affect the risk associated with a particular business or business activity. To facilitate this process, insurance carriers develop underwriting rules for different classifications of insurance that are normally used by a carrier's underwriters to determine whether to insure the risk and to assign a premium to the risk. These underwriting rules are often proprietary to a carrier. The process of obtaining a risk analysis and subsequent insurance premium quotations or policy quotes for a carrier is often quite complex and requires the underwriters to undergo a detailed evaluation using the carrier's underwriting rules. This process can be very labor intensive and time consuming, often lacking controls or checks and balances to ensure that the carrier's risk comfort level is aligned with the actual risk it ends up writing.

Notwithstanding attempts to automate this process, insurance carriers are often forced to divert the analysis of risk from their automated systems to underwriters for additional analysis outside of the normal automated work flow (a manual system). This analysis does not allow for real time communication with agents, thereby increasing the amount of time required to determine the acceptable premium amount for a policy or to deny coverage. A manual process also increases the chances of offering quotes for risks that are outside of the carrier's underwriting/risk parameters (due to lack of controls of underwriting authorities). Therefore, there is a need for a web-based automated system that simplifies the process of analyzing risk, establishes a task based work flow process that enables underwriters to analyze risk within the context of the automated system and that allows the system to communicate the determination of coverage and pricing information developed from the task based work flow process in real time with agents while maintaining pricing and underwriting controls predetermined by the carrier. This system thereby facilitates an expedited, yet accurate, means of obtaining insurance quotations from an insurance carrier which decreases the time necessary for analysis and decreases the transaction costs associated with that process.

It is evident from the above discussion that an ongoing need exists for improved ways to set up the automated insurance policy underwriting.

### SUMMARY OF THE INVENTION

The present invention solves the above and other problems, thereby advancing the state of the useful arts, by providing methods and associated systems, for example for enabling an effective way of managing insurance policy underwriting.

The invention relates to an automated system used by an insurance carrier that is used by the carrier for evaluating insurance risk and for setting optimal premiums for policies where the carrier's underwriters act as traders of the risk by relying on the system to determine whether to issue policies and to determine a range of appropriate premiums. An embodiment of the present invention is used to (i) determine an acceptable premium quotation for an insurance policy, (ii) deny coverage for a potential insured or, in the event the system is unable to determine (i) or (ii), (iii) provide for a totally automated, task based work flow process that enables underwriters of the carrier to act as traders of the risk, evaluating risk and communicating on a real time basis with agents as to either (a) an acceptable price for the insurance policy based on an optimal price determination by the system (using minimums and indicated premium ranges derived from a carrier's proprietary pricing methodology), or (b) the denial of coverage. An embodiment has integrated controls which operate to dictate the work flow and place checks and balances on the system's users, including underwriters, to make sure that no user exceeds an authority level established by the carrier and that all matters are escalated to the appropriate level of authority within the insurance carrier for resolution. In an embodiment, no insurance risk is quoted until the risk is fully evaluated by the system. All risk analysis may be based on a set of proprietary underwriting criteria determined by the insurance carrier based on particular risks (both pricing and underwriting) for the potential insured.

An embodiment includes a process for evaluating insurance risk and trading the risk through pricing of an insurance policy and supporting the underwriting process and the carrier's agents through out the automated, web-based, paperless application process.

An embodiment includes an automated system used by insurance carrier for evaluating insurance risk based on underwriting information, including an agent interface; a database comprising underwriting information and associated underwriting rules established by a carrier; and an automated system connected to the agent interface and the database through a network. For this embodiment the automated system may receive insurance information from the agent interface, store the insurance information on the database, retrieve the respective underwriting rules from the database, and process the insurance information. The embodiment may perform a risk analysis against underwriting and pricing rules, wherein in response to the system analysis, a premium quotation is issued or a denial of coverage is issued, based on the automated system's risk assessment.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 illustrates the general architecture of a system for policy underwriting and risk management over a network in accordance with one embodiment of the present invention;

FIG. 2 illustrates a schematic representation of the policy underwriting system over a network according to an exemplary embodiment of the present invention;

FIG. 3 illustrates various databases of the underwriting system according to an exemplary embodiment of the present invention;

FIG. 4 is a flow diagram illustrating the underwriting process according to an exemplary embodiment of the present invention;

FIG. 5 is a flow diagram illustrating process and task work flow according to an embodiment of the present invention;

FIG. 6 is a user interface table showing a list of exemplary tasks according to an embodiment of the present invention;

FIG. 7 is a user interface feature for adjusting task authority according to an embodiment of the present invention;

FIG. 8 is a exemplary user interface feature for indicating injury information according to an embodiment of the present invention; and

FIG. 9 is an exemplary user interface feature for entering and modifying codes in a system according to an embodiment.

### DETAILED DESCRIPTION OF EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

As used in this application, the terms “component” and “system” are intended to refer to a computer-related entity, either hardware, a combination of hardware and software, software, or software in execution. For example, a component can be, but is not limited to being, a processor, a process running on a processor, a hard disk drive, multiple storage drives (of optical and/or magnetic storage medium), an object, an executable, a thread of execution, a program, and/or a computer. By way of illustration, both an application running on a server and the server can be a module. One or more components can reside within a process and/or thread of execution, and a module or component can be localized on one computer and/or distributed between two or more computers.

As used herein, the terms “desktop,” “PC,” “local computer,” and the like, refer to computers on which systems (and methods) according to the invention operate. In the illustrated embodiments, these may be personal computers, such as portable computers and desktop computers; however, in other embodiments, they may be other types of computing devices (e.g., workstations, mainframes, personal digital assistants or PDAs, music or MP3 players, and the like).

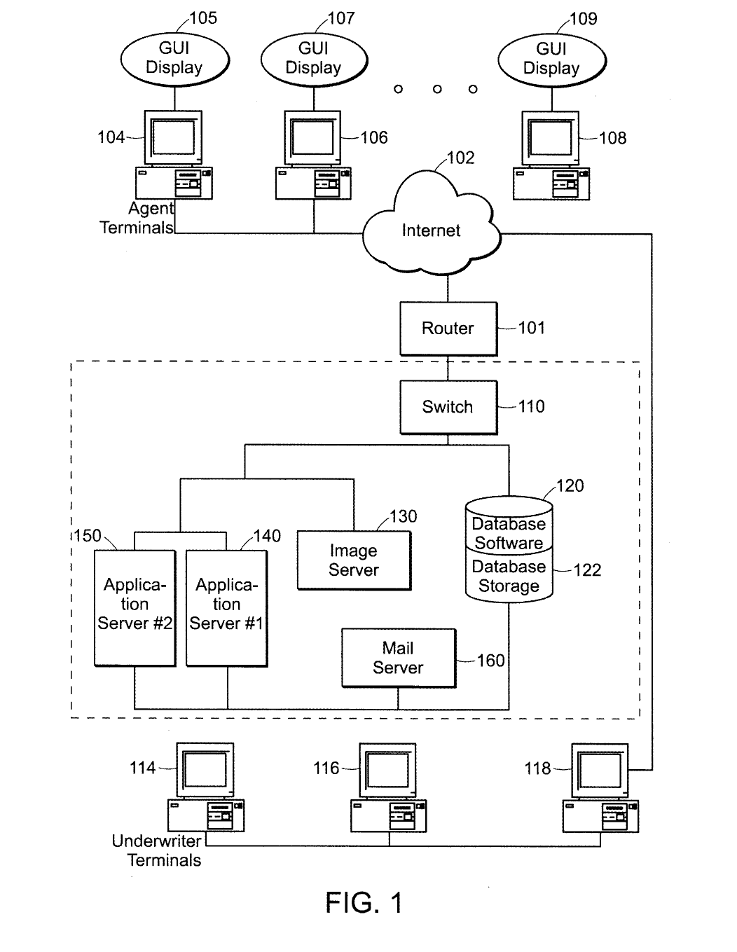

FIG. 1 illustrates the general architecture of a system that operates in accordance with one embodiment of the present invention. As shown in FIG. 1, a plurality of graphical user interface (GUI) displays 105, 107, 109 are presented on a plurality of agent computers 104, 106, 108 connected to a system 100 via the Internet 102. Similarly, a plurality of graphical user interface (GUI) displays, not shown, are presented on a plurality of underwriter terminals 114, 116, 118 connected to the system 100 via the Internet 102.

The user interface may be any device capable of presenting data, including, but not limited to, cellular telephones, television sets or hand-held “personal digital assistants.” The agent computers 104, 106, 108 and the underwriter terminals 114, 116, 118 may comprise any computing device known in the art, such as a server, mainframe, workstation, personal computer, hand held computer, laptop telephony device, network appliance, etc. As used herein, the term “Internet” generally refers to any collection of distinct networks working together to appear as a single network to a user. The term refers to the so-called world wide “network of networks” that are connected to each other using the Internet protocol (IP) and other similar protocols. The Internet provides file transfer, remote log in, electronic mail, news and other services. As described herein, the exemplary public network of FIG. 1 is for descriptive purposes only. Although the description may refer to terms commonly used in describing particular public networks such as the Internet, the description and concepts equally apply to other public and private computer networks, including systems having architectures dissimilar to that shown in FIG. 1. For example, and without limitation thereto, the system of the present invention can find application in public as well as private networks, such as a closed university social system, or the private network of a company, such as an intranet or virtual private network.

The system 100 is connected to the Internet 102 through a router 101 and a switch 110. As is well known in the relevant art(s), routers forward packets between networks. The router 101 forwards information packets between the system 100 and devices 104, 106, 108 over the Internet 102. The switch 110 may act as a gatekeeper to and from the Internet 102. The components appearing in the system 100 refer to an exemplary combination of those components that would need to be assembled to create the infrastructure in order to provide the tools and services contemplated by the present invention. As will be apparent to one skilled in the relevant art(s), all of the components “inside” of the system 100 may be connected and may communicate via a wide or local area network (WAN or LAN).

The system 100 includes an application server 140 or a plurality of application servers 140, 150. Yet another server is the image server 130, which has the purpose of storing and providing digital images to other components of the system 100. Also included is a mail server 160, which sends and receives electronic messages to and from the agent computers 104, 106, 108 and the underwriter terminals 114, 116, 118. Also included are the database software 122 and a database 124.

The system 100 sends out Web pages in response to Hypertext Transfer Protocol (HTTP) requests from remote browsers (i.e. users of the system 100). That is, the system 100 provides the GUI 105, 107, 109 to users of the system in the form of Web pages. These Web pages sent to the agent computers 104, 106, 108 and the underwriter terminals 114, 116, 118 would result in GUI screens 105, 107, 109, 115, 117, 119 being displayed.

The system 100 also includes a second switch, not shown, that allows the components of the system to be interconnected in a local area network (LAN) or a wide area network (WAN). Thus, data can be transferred to and from the various components of the system 100.

As will be appreciated by those skilled in the relevant art(s), this configuration of a router 101 and switch 110 is flexible and can be omitted in certain embodiments. Additional routers 114 and/or switches 116 can also be added.

The application server 140 may include a central processing unit (CPU), a random access memory (RAM) for temporary storage of information, and a read only memory (ROM) for permanent storage of information. Computer server 132 may be generally controlled and coordinated by operating system software. The operating system controls allocation of system resources and performs tasks such as processing, scheduling, memory management, networking and I/O services, among other things. Thus, the operating system resident in system memory and executed by CPU coordinates the operation of the other elements of the system 100.

Although the description of the application server 140 may refer to terms commonly used in describing particular computer servers, the description and concepts equally apply to other processing systems, including systems having architectures dissimilar to that shown in FIG. 1.

The mail server 160 is a repository for e-mail messages received from the Internet 102. It also manages the transmission of electronic messages (“electronic mail” or “e-mail”). The mail server 160 consists of a storage area, a set of user definable rules, a list of users and a series of communication modules.

The databases 120, 122 store software, descriptive data, digital images, system data and any other data item required by the other components of the system. The databases may be provided, for example, as a database management system (DBMS), and object-oriented database management system (ODBMS), a relational database management system (e.g. DB2, ACCESS etc.), a file system or another conventional database package. Thus, the databases 120, 122 can be implemented using object-oriented technology or via text files. Further, the databases 120, 122 can be accessed via a Structured Query Language (SQL) or other tools known to one of ordinary skill in the art.

An embodiment of the present invention is directed towards a method and system for collecting insurance information and providing premium quotations, either automatically or through a totally automated, task based work flow process. This embodiment enables underwriters to evaluate the risk and communicate on a real time basis with agents as to either (a) an acceptable price for of the insurance policy or (b) denial of coverage. The system has two aspects. One aspect of the present invention relates to the agent's ability to input risk information into an automated system using a web-based agent interface and receive, on a real time basis, either an immediate quote for an insurance policy or notification of denial of coverage. This method involves the analysis of information input by agents into the system using predetermined underwriting and pricing rules to determine the appropriate outcome. This requires no human/underwriter intervention.

The other aspect of the system is, in the event the risk cannot be quoted based immediately on a real-time basis by the system, the risk is directed into an automated, task based work flow process that engages an underwriter of the insurance carrier in to the risk analysis on a real time basis. This aspect of the system allows for an underwriter to obtain information necessary to maximize the pricing of a policy and select a price quotation within the carrier's predetermined minimum and indicated price ranges (optimal price) that adequately provides for the risk associated with the particular insured. A feature is that the underwriting process is fully automated and provides support for the entire process, from additional information collection through analysis of additional risk factors, to be done within the automated system. This allows the insurance carrier to be in constant real time communication with its agents and provide underwriters with a system that can maximize the amount of information collected from the agent, the quality of the information collected from the agent and accuracy of risk analysis and pricing. Because the system provides for this real time information collection and provides underwriter with a task based work flow to follow to gather only relevant information, it enables the insurance carrier, through the underwriter, to maximize the pricing for any given policy and to maximize the efficiency of the underwriting process. Through the creation of this real time process, the insurance carrier is better able to serve its agents, encourage efficient communications and issue more accurate quotations. All of these results maximize the profit of the insurance carrier.

An embodiment of the present invention commences its risk analysis upon receipt of underwriting information input by agent through a web-based agent interface. The underwriting information is submitted for the purpose of a premium quotation. The information is received by the automated system and is stored in a database. The automated system reviews the information against underwriting rules to evaluate risk and, alternatively, either returns a premium quotation, denies coverage and does not return a quotation or submits the information to a task-based work flow process that enables an underwriter to evaluate the information on a real time basis and maximize the pricing for the policy, it is the ability of the system to submit the information for further review through the task based work flow process and ultimately either select a price quotation within the carrier's predetermined minimum and indicated optimal price or deny coverage that comprises the other aspect of the system, in either case, the agent may utilize the price quotation returned by the system to place a policy. The expeditious, real time nature of the system enables the insurance carrier and its agents to more efficiently write business, thereby maximizing revenues.

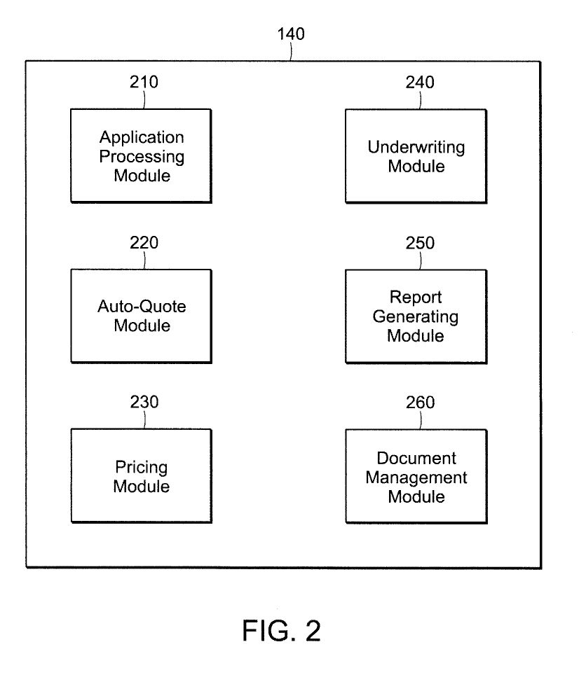

The system 100 includes a web-enabled application that allows an insurance provider, or carrier, to gather underwriting information for producing a decision on an applicant's insurability. Referring to FIG. 2, the system 100 comprises an application processing module 210. The application processing module 210 integrates a risk assessment questionnaire with underwriting rules to create an interactive questionnaire for assessing risk in insurance cases. The questions are generally of the type printed on a traditional insurance application form. Depending on the answers to the beginning questions, the application processing module 210 prompts the applicant to disclose further information about various conditions. Typically, each condition disclosed by the applicant will have a set of drill down or detail questions associated with it. The drill down questions are designed to gather further specific details in a controlled form. The system 100 presents questions to the applicant one at a time and the applicant's answer determines which question will be asked next in the sequence. In one embodiment of the invention, the system 100 provides graphical interfaces for presenting questions in the form of two side-by-side frames.

Agents and underwriters may use the underwriting system 100 to write a new policy for an existing account, to change an existing account, to write renewals, to write new business, to write a policy for an individual peril, to write a policy for a multi-peril, to resolve ambiguous addresses, to view selected locations on an interactive map, to save locations to a company, and to review and/or approve a prospective policyholder.

As for writing a new policy for an existing account, the system 100 has an existing account for a customer. The agent or underwriter wants to quote a new policy for the customer. The system 100 verifies information related to the account.

As for writing renewals, when an insurance company has an existing policy that is up for renewal, the agent or an assessing module determines whether the renewal is accepted, declined, or requires further review. If the renewal can be accepted or declined at the agent level, the report would be sent to the existing customer for renewal. If the renewal requires further review, the server would transmit the renewal application to the underwriter for assessing whether or not to renew the policy based upon the underwriting guidelines set by the insurance company. With the system 100, the underwriter uses the policy number as the unique identifier for reviewing the policy and checks the policy to determine whether to write the policy.

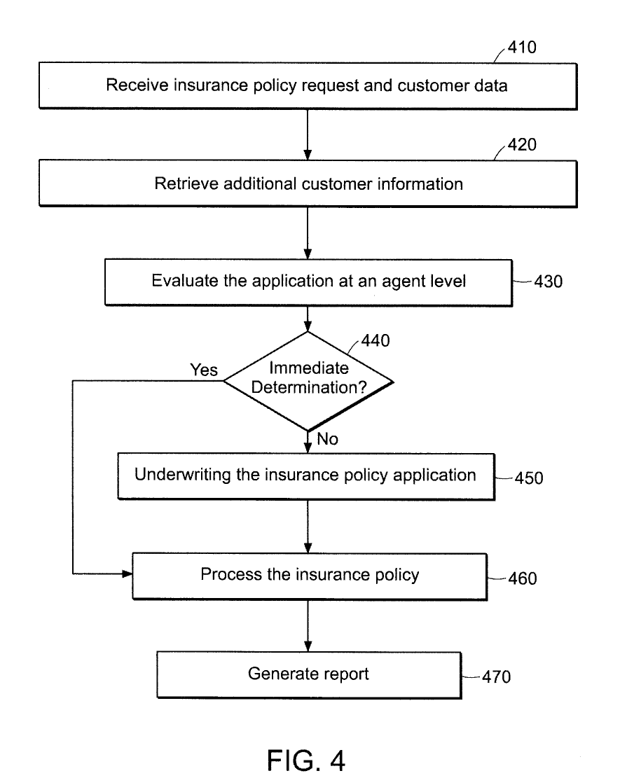

Referring to FIG. 4, at the step 410, the insurance agent may receive existing or prospective customer data for the desired policy such as: 1) the name and address of the entity seeking coverage (e.g. an individual or a company name and the address of the property to be covered); 2) the requested coverage type (e.g., property insurance for a loss resulting from a terrorist attack and/or some other peril); and 3) the desired amount of coverage, deductible and premium. The request and the existing or prospective customer data may be submitted to the insurance agent, or any other insurance company representative, using any conventional means.

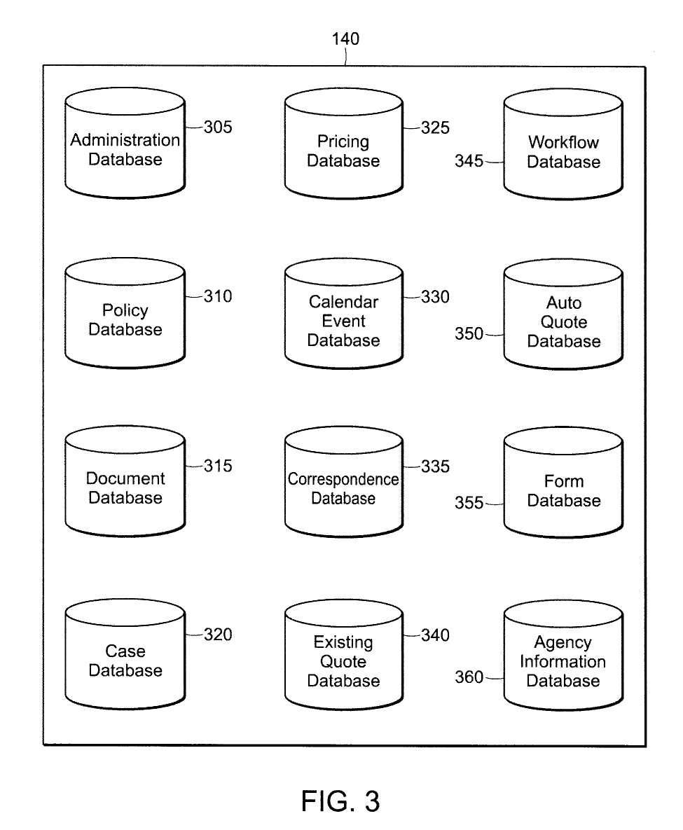

Referring to FIG. 3, the database storage 122 comprises various databases, including an administration database 305, a policy database 310, a document database 315, a case database 320, a pricing database 325, a calendar event database 330, a correspondence database 335, an existing quote database 340, a workflow database 345, an auto quote database 350, a form database 355, and an agency information database 360. An application executable code consists of the software code executed by the CPU during the operation of the underwriting system, such operation implemented by various processes and graphical user interfaces (screens) to be described later. The administration database 305 contains user names and passwords for all users (agents and underwriters) that are authorized to use the underwriting system 100 (when a user logs in, he or she enters his/her name and password at the input device and they are checked against those stored in the administration database 305). The case database 320 stores data entered or collected (e.g., at the input device) on individual insurance applicants and that is used by either the agent or the underwriter to determine the insurability, mortality and a rating for those applicants.

The policy database 310 stores preloaded information on various policy rules and conditions, including medical and other conditions, and ratings and other insurability/morality information pertaining to those conditions, that both an auto quoting module and an underwriter will need to consider in evaluating the insurance policy application. Such information will likely be vast because of the thousands of potential conditions that might be applicable to insurance applicants and would include, for example, information originating from underwriting manuals, medical books, and other public sources that is stored electronically in database for easy access by the underwriter.

In one embodiment, an insurance agent enters the information. In another embodiment, the information is entered by a third party that is privy to the information (e.g., a bank, credit card company, retail sales store, club, fraternal organization, social organization, charitable society, doctor's office, medical insurance company, etc.).

When the user (the agent or underwriter) enters the system, the user's name and password are checked at the administration database 305, and if the user is authorized, he or she may proceed with underwriting. Underwriting cases may either be new or already established, and if new, the underwriter may establish or assign himself as the responsible underwriter.

In some cases, as will be described below, various kinds of data may be imported from an administrative system and need not be entered at the system 100. For example, if personal information on the insurance applicant (e.g., name, age, birth date, gender) has already been collected directly from the applicant at the centralized administrative system (e.g., entered by a clerical employee from information received from the applicant over the telephone or from an insurance application), it can then imported into system 100 so that basic information will have been pre-loaded or stored relative to a case (i.e., a proposed insurance policy) before the case is accessed by an underwriter. As another example, the administrative system may assign underwriters to cases as they are received at the administrative system, so that when an underwriter enters the system 100, he will see both old cases already worked on as well as new cases that have been assigned to him/her. In the process illustrated, the underwriter would most likely have also received a physical file containing the insurance application, medical information (such as medical exam report, attending physician statement, etc.) and can begin using the system by first entering data (e.g., applicant information if not preloaded by the administrative system) and other pertinent information on the applicant (e.g., medical exam or lab results). The agent can search and retrieve stored information with a FEIN (Federal Employer Identification Number), a policy number, a postal code, status, or NCCI (National Council on Compensation Insurance) number.

With respect to browser presentation, in one embodiment, the system 100 presents a tabbed dialog user interface for navigating user. Once all of the information on a tab is complete, the system 100 permits next tab to be viewed. The user interface provides additional buttons to expand and collapse all detail question branches. After each question is answered, the user interface advances focus via auto-scrolling to the next unanswered question of the application, where possible. The system 100 also provides the option to automatically re-position the questionnaire so that the next unanswered question is displayed at the top of the screen.

This tab presents the questions used to determine if the applicant is accepted, denied, or if the decision should be postponed for a period of time or referred to an underwriter for a life insurance policy. This decision is based, of course, upon the applicant's answers to the base and detail questions.

In one embodiment, the information gathered about the customer is done in stages. For example, at a first stage, a customer is asked for a certain set of information. A feature of this embodiment is that the information requested at each stage is limited, and an agent of prospective customer does not have to enter all information at one time, thereby minimizing the data entry for the user and improving their interactive experience. One example of this feature is that an agent does not need to provide insured address information until when they choose to accept a quote and bind the offer. As another example, the information requested at a second stage is determined at least in part from information entered at a first stage. In one embodiment, part of the information entered is the customer's signature; this signature may be an electronic signature.

It is determined from any of the information entered whether any additional information is desired. For example, if a user enters that the potential customer has a heart problem, it may be determined that more specific information about the potential customer's heart health is required. If no additional information is desired, the drill-down process is complete. If additional information is desired, the process repeats.

Referring back to FIG. 4, at the step 420, information about a customer is used to automatically retrieve additional information. In one embodiment, information about a customer (e.g., the customer's name and/or social security number) is used to retrieve a customer's driving record. In another embodiment, information about a customer is used to retrieve a customer's medical record. In one embodiment, the customer's medical record comprises the customer's pharmaceutical records.

At the step 430, the application is automatically evaluated by the system at the agent level. The system 100 may integrates a risk assessment questionnaire with underwriting rules to create an interactive questionnaire for assessing risk in insurance cases. In operation, the system 100 executes the auto-quoting rules to render a decision whether to accept or deny the applicant, postpone the decision, or refer the case to an underwriter based on the information gathered from the applicant through these questions.

In one embodiment, the information about the customer is used to determine whether the customer meets the criteria for automatic policy denial. If the customer meets the criteria for automatic policy denial, the customer is automatically denied a policy. In one embodiment, the customer's information is compared to more than one insurer's approval/denial criteria. In one embodiment, when certain customer information is entered (e.g., one of a range of scores or one or more flags are associated with the customer information), the customer's information is automatically sent to an agent for review. The agent can review the information and request additional information from the customer and/or electronic databases or issue or deny a policy.

With reference to FIGS. 2 & 3, the system 100 comprises an auto-quote module 220 and a pricing module 230. The auto-quote module 220 may make an initial evaluation using any predetermined insurance company standard. For example, the auto-quote module 220 and/or the auto-quote rule database 350 may be programmed to evaluate the new policy application and whether the PML exceeds a predetermined PML limit. If the PML limit is not exceeded, a report may be sent back to the agent computer 104 to indicate that the new policy may be issued. Alternatively, if the PML limit is exceeded, a report may be sent back to agent computer 104 to indicate to the insurance company representative that the new policy may not be issued or that further information may be considered before the policy may be accepted. In another embodiment, the auto quote module 220 evaluates the application based upon, but not limited to, an eligibility standard, a location of the insured or its property to be insured, a loss history, a payroll, class codes, the state, the state rules, premium limits, desired premium, and/or debit/credit rules. However, those skilled in the art appreciate that the predetermined insurance company standard for the evaluation is not limited to the example described above. Those skilled in the art understand that the auto-quote module 220 may be programmed to make an evaluation of whether to underwrite a policy using any predetermined standard desired by the insurance company.

At the next step, the auto quote module 220 begins the actual quoting process by determining if any disclosed condition (medical or other conditions) requires a “rating”, i.e., a debit or credit of points reflecting the insurability/mortality of the applicant. In the system 100, such ratings are stored in the policy database 310 or the pricing database 325 and, once a condition is identified and the corresponding rating determined and displayed at the display, it may be selected by the underwriter and automatically transferred into the applicant's case (as maintained in the case database 320).

In operation, the auto quote module 220 may execute a set of processing rules to render a decision based on the information gathered from the applicant through these questions. The auto quote module 220 automatically decides whether to accept, decline, or postpone coverage, apply premium loadings, or request medical reports. The auto quote module 220 may refers complex cases for manual underwriting.

The pricing module 230 estimates loss and expense savings a carrier could realize versus the current self insured program. Information on terms and pricing of recent deals for other customers is used to obtain an industry average estimate of savings from insurance. The price of the premium can be calculated based upon, but not limited to, the rate, premium, waivers, deductibles, premium discount factors, minimum premium, and/or terror charge. The pricing database 325 stores a plurality of rating tables, such as loss costs, premium discounts, class codes, deductibles, and/or employer liability limits.

In order to determine the appropriate premium to charge an insured, the auto quote module 220 and the pricing module 230 setting the premium must have an accurate assessment of the insured's total exposure. An insured's total exposure is often based on criteria such as, for example, the total dollar volume of the insured's sales, the type of business engaged in by the insured, the total payroll of the insured, the number and types of vehicles used by the insured, etc.

If the auto-quote module 220 issues or denies the insurance policy, at the step 440 FIG. 4, a report may be generated for the applicant. The report may be sent to the applicant via e-mail or mail. On the other hand, if the auto-quote module 220 determines that further review is required, the application may be sent to an underwriter. The system 100 generates the agent's report for the underwriter. The agent's report presents loss runs, claim information, payment history, and promotion summary.

When the auto-quote module 220 determines that further review is required, the application and the agent's report are sent to an underwriter. The system 100 assigns the application to one of the underwriters. The assigned underwriter is notified by the system 100 and receives all the disclosed information with the agent's report. Further, the system allows the underwriter to retrieve the agent's information from the database.

At step 450 FIG. 4, the assigned underwriter reviews the agent's evaluation. The underwriter can use the underwriting module 240 which provides step-by-step analysis of the insurance application. As part of the initial underwriting, the underwriter may need additional information. For example, if a past disease has been identified, the underwriter may want assurances that it has been completely resolved and is no longer a factor in the applicant's mortality. The underwriter may want a statement from the applicant's physician to that effect.

If the underwriter needs to communicate with the agent, the system allows the underwriter to communicate with the agent via network in real-time, such as e-mail or other electronic messaging systems. This workflow expedites the underwriting process.

The underwriter's decision (accept, decline, accept with additional premiums because of ratings above standard, postpone because of unresolved conditions etc.) is then communicated to the agent or the underwriter's assistant. The communication is normally made to a management reporting system, which can generate, for example, letters or e-mail to the applicant's agent. At the same time, a report can be made back to the administrative system, which may be used to maintain information on applicants, as well as issue and maintain insurance policies (e.g., send out premium notices). Once the underwriter has completed underwriting, and communicated the decision, the process ends.

At the step 470, a report is generated after the underwriting process ends. A user may view, save, export or close such a report. Detailed views into the resulting policy details are company specific. Certain views of the reports may include displays by policy and location, by coverage and by peril zone, etc. Role-based access allows some users with an internal role (e.g., company employees) to have detailed views into the rating results and some users with an external role (e.g., external agents) to have a write/reject new business view. Users with an internal role have access to view full details and have drilldown capability.

An embodiment includes a document management module 260 FIG. 2. The document management module 260 provides ability to manage many different types of documents and all of its components that make it. Each document has different templates which can be ordered by the use of drag and drop. A template represents one or more pages of a document. All templates have distinct properties. The majority of the templates are XSLT style sheets. When an XSLT style sheet is combined with an XML file, dynamic content is provided in almost real-time document generation. The templates that make up a document have an order in which they will be displayed in a generated document. Clicking edit button displays options to re-order, add, or delete templates. This queue of document templates contains all possible templates that can make up a document. Each template has a set of rules that define when certain templates should be included in the document generation process. A document indexing interface allows for incoming documents to be associated with the appropriate claim, policy or agency. The incoming categories or tabs can be administratively defined to look at virtually any network location, creating a consolidated single point of view. Documents can be created by merging dynamic data with static form templates stored in a template library.

In order to maintain audit trails of document changes and revisions to meet business and legal requirements, generations of data will be stored in the database with date/time stamps so at any point in time, a document can be reconstituted for viewing and printing as it appeared when it was initially created prior to latest endorsements or modifications.

In general, an agency portal according to one or more embodiments may be configured to provide one or more of the following functionalities to the agent:
Two-step or three-step submissions process with logic behind each page to either quote, decline or refer to an underwriter for review
Automatic quotes for eligible classes and accounts based on proprietary pricing and class logic
Search for class code eligibility criteria feature
Submit new and renewal business for quotes
Bind online for new and renewal business and receive binder confirmations and policy numbers
View quotes, policies and renewals in a queue format/view
Home page design is user-specific
Message back and forth with underwriter and other internal users on an account level
View issued policy information including billing information
Insured parties can submit payments online
Forms are accessible through the portal
Basic reports available on commission, policy information
Transaction-level audit trail logged

A submission manager according to one or more embodiments may include the following functionalities for an underwriter:
Quoting and declining of new business submissions
Quoting and non-renewals of renewal business
Direct link to NCCI's website to look up and log experience modification factors
Instant notification of submissions which need to be reviewed via task-based system
Approval levels to allow for supervisor review on higher risk submissions via referral logic
Messaging feature to communicate with agents on a real-time basis
Paperless—all documents related to the submission process are online
Proprietary pricing methodology allows for indicated premium levels based on risk characteristics (state, territory, class, loss history)
a “Risk trading” approach to underwriting risk
Transaction-level audit trail logging.

A policy manager may be configured according to one or more embodiments to include the following functionalities to internal users:
Issuance of policies—new, renewal
Instant document generation upon issuance and endorsement
Endorsement wizard for processing endorsements
Ability to endorse policy after issuance
Entry of endorsement data into reportable fields
Ability to view new and previous values for endorsements
Processing of premium audits
Instant document generation
Automatic selection of policies to be audited
Automatic endorsement based on approved audits
Ability to track and manage audits via workflow-based rules
Processing of loss control surveys
Instant document generation
Automatic selection of policies eligible for loss control surveys
Ability to track and manage loss control surveys
Transaction-level audit trail logged

An accounting manager according to one or more embodiments may be linked to all the other modules through a single database, and may be configured to provide one or more of the following functionalities to internal users:
Applying of manual payments
Applying payments automatically from third party vendors based on FIFO rules
Issuing of refunds for credit balances
Marking funds as Non-sufficient
Ability to write-off fees
Ability to apply payments received by third party that could not be automatically applied
Ability to track purchase orders from a company requested services (medical bill reviews, premium audits, loss control surveys)
Ability to migrate the system information into third party accounting applications
Ability to view third party data or files regarding payments made by a company.
Ability to view any exceptions appearing on payment statements
Transaction-level audit trail logging.

A claims manager according to one or more embodiments may be linked to all the other modules through a single database, and may be configured to provide one or more of the following functionalities to internal users:
New claim set up and management via percentage completion indicator
FROI (first report of injury) wizard with human body graphic and point and click indication of injury automatically logged and tracked “Maverick Man”
Home page design specific to the user
Instant notification of new claim setup via task-based workflow system
Entry of claims data into reportable fields
On-line access to all documents related to the claim
Proprietary reserving engine based on company and injury-specific data using ICD9 codes
Indication of an insurance company's history of paid values on a particular injury
Ability to make payments
Referral logic and escalation workflow based on predetermined authority levels
Automatic approval of medical bills to be reviewed by third party medical review company
Posting of recovery and deductible payments
Transaction-level audit trail logged
Maintaining claim contact information
Indication of litigation on a claim

A resource manager according to one or more embodiments may be configured to provide one or more of the following functionalities to administrators:
Setup of user, agents and partners specific permissions to view, functions, reports and portals rights
Third party vendor setup
Ability to update pricing data
Ability to update partner and agency new displayed on home page
Management of agency commission paid
Transaction-level audit trail logging
Workflow setup for all modules
Claims compliance prerequisites
Claim administrative setup (reserving, code management, etc.)

A document manager according to one or more embodiments may be configured to provide one or more of the following functionalities to administrators:
Users able to attach documents to a claim, policy or agency
Transaction-level audit trail logging

A partner portal according to one or more embodiments may be configured to provide one or more of the following functionalities to partners:
Enables third parties to access relevant policy and claim data with restrictions
Enables third parties to access relevant reports
Home page design specific to the user

An agency manager according to one or more embodiments may be configured to provide one or more of the following functionalities to agency appointment personnel:
Manage agency appointment process via task-based workflow system
Referral logic built in for escalation based on pre-determined authority levels
Ability to turn on/off agency access based on approval status
Automatic email of usernames and password for appointment agencies
Link to a company website for agency appointment questionnaire and submittal process
Lead generation process for inside sales staff to identify and track prospective agencies via workflow/task system
Ability for users to follow up on and indicate status of quotes and submissions
Transaction-level audit trail logging

A sales management system according to one or more embodiments may be configured to provide one or more of the following functionalities to sales management system users:
Set up and track appointments to agencies
Map out agency location to obtain directions
View agency-level activity and summary statistics
Transaction-level audit trail logging

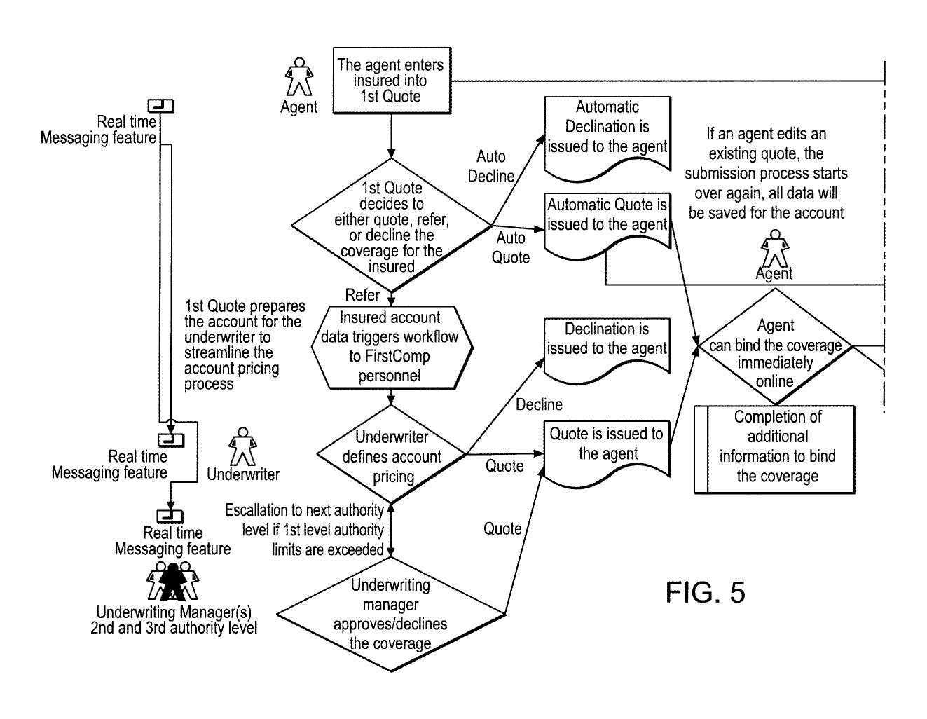

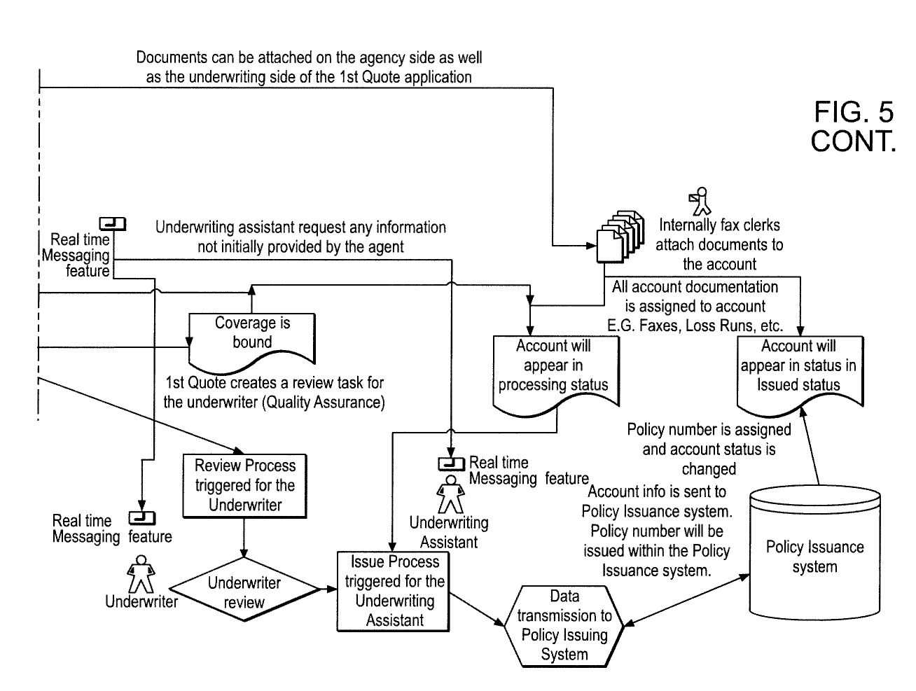

FIG. 5 illustrates exemplary work flow and task creation according to an embodiment. This embodiment utilizes tasks in the form of real-time messages that may be automatically generated and sent to the appropriate party to handle the task. Such tasks may be utilized by every user of the embodiment, and may be utilized at any stage, even after a policy has issued. This embodiment allows all workflow steps to be controlled by such tasks, and such standard procedures may be embodied by automatic creation and use of such tasks. Any step in the process may generate one or more tasks, that are assigned to one or more appropriate parties. The completion of a task may trigger one or more additional tasks, thereby instantiating the “next step” in a workflow process. This creates a unique environment for users, with intelligent workflow and an ability to monitor and control the process. Further, assigned tasks and steps can not become overlooked or lost.

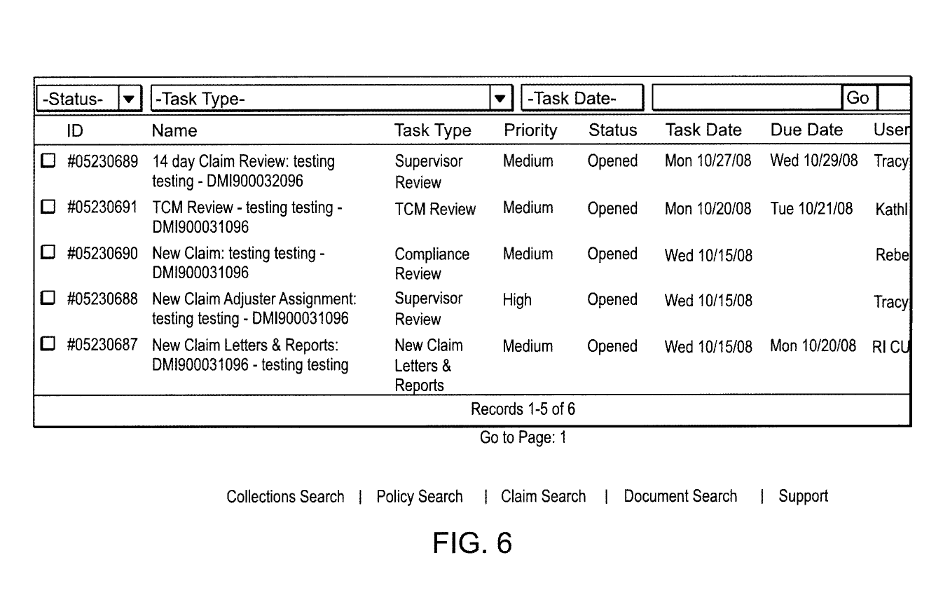

FIG. 6 illustrates a list of exemplary tasks for an embodiment. Each user of such a system will have access to their own list of tasks, which may be updated in real-time. A user may sort or filter their task list by various parameters, for example by date, status or task type. As previously discussed, the completion of a task may trigger the creation of other tasks that may be assigned to other parties to perform.

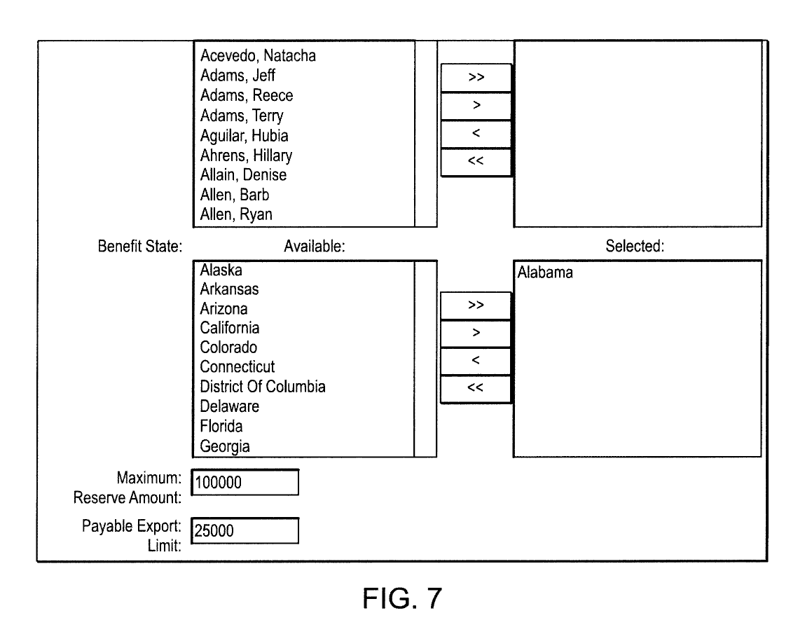

A feature of this task system is illustrated in FIG. 7, with regard to authority levels. In an embodiment with multiple users and multiple authority levels, tasks can be automatically directed to an appropriate authorized party. As an example for an insurance system, an agent may only be authorized to a certain maximum reserve amount for a policy claim. If the agent wishes to reserve a higher amount, the amount will need to be approved by another party within the organization (or other authority). In this embodiment, if an agent requests a reservation amount above their authorized maximum, the system will generate a task to have the higher reservation amount reviewed and approved. This task will then go to an appropriate party for approval. As shown in FIG. 7, the maximum reserve amount for individual users of the system may be set (for example by a system administrator), wherein any request to exceed this amount will result in generating a task for approval.

Another feature of this embodiment is that such tasks will be sent to the proper party for approval. Continuing with the previous example, if a user (such as an adjuster) requests a reserve amount that requires approval, the approval task will be sent to a party who has the proper authority for the necessary approval. Different parties may have different authority levels for how much they are authorized to approve. The embodiment allows the tasks to be automatically sent to an appropriate party for approval. Therefore if approval is needed for a reserve of $5000 (for example), the task will automatically be sent to a party with the authority to approve that reserve amount.

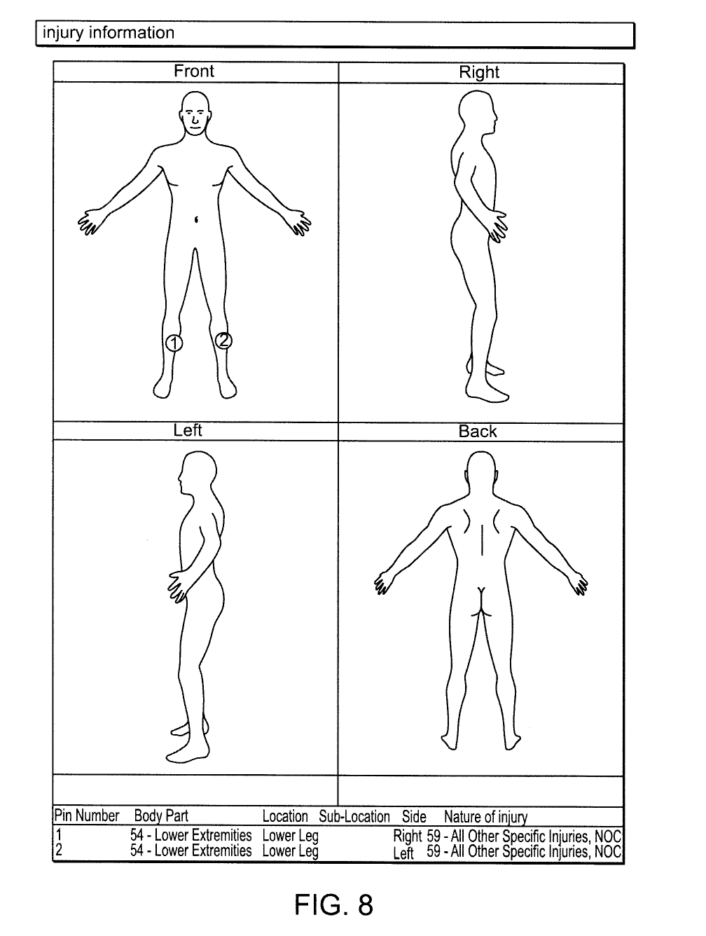

FIG. 8 shows a feature of an embodiment that assists with allowing streamlined entry of information regarding claims for injuries, as previously described. As an example regarding workers compensation insurance, an agent entering a claim will need to provide information regarding the injury for which the claim is presented. This embodiment is designed to allow agents to report and file such claims as quickly and easily as possible. As part of an injury claim, information typically must be entered regarding the body sites or parts that were injured. This information is often required in the form of codes, which require lookup and entry by a user. An embodiment displays graphic user interface (GUI) with a human figure, wherein the user can point and click on the site of the injuries. As shown in FIG. 8, a user has indicated the site of the injuries by clicking on the human figure, and the labels “1” and “2” indicate the selected sites. The selected site on the human figure is mapped to specific identification codes. In a window below the human figure, the proper codes for the selected sites are automatically determined and displayed, in this case code 54, which indicates the lower leg. Further information or subcodes is also automatically determined, such as left or right leg, and type of injury. Industry standard codes may be utilized, or system specific codes. The proper codes and information may then be automatically entered into the claim filing.

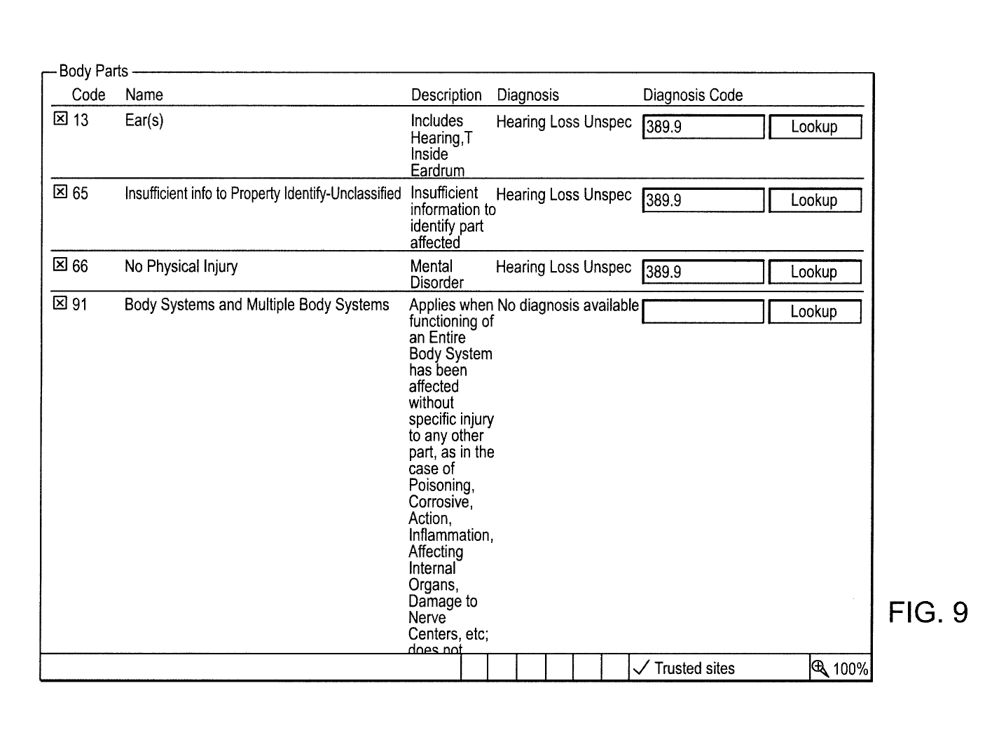

FIG. 9 shows an administrative screen for setup and editing information regarding body part and injury codes according to an embodiment. These codes may also be linked to specific injuries and other information such as estimated or typical costs related to treatment of such injuries. This information is helpful, for example in determining a reserve amount an insurance provider should set for a claim.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that relative terms are intended to encompass different orientations of the device in addition to the orientation depicted in the Figures.

Moreover, it will be understood that although the terms first and second are used herein to describe various features, elements, regions, layers and/or sections, these features, elements, regions, layers and/or sections should not be limited by these terms. These terms are only used to distinguish one feature, element, region, layer or section from another feature, element, region, layer or section. Thus, a first feature, element, region, layer or section discussed below could be termed a second feature, element, region, layer or section, and similarly, a second without departing from the teachings of the present invention.

It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Further, as used herein the term “plurality” refers to at least two elements. Additionally, like numbers refer to like elements throughout.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow. The scope of the disclosure is not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims.

What is claimed is:

1. A method of processing a plurality of premium quote requests comprising:
receiving an insurance policy request and customer information over a network;
evaluating the customer information in relation to a predetermined set of underwriting criteria that is stored in a database; and
based on the process of evaluating, performing one of: automatically generating a premium quote, automatically indicating that no quote will be provided, or forwarding the policy request and customer information to an underwriter for further evaluation.

2. The method of claim 1, wherein the customer information includes a name and address of the requesting entity the requested coverage type, a desired amount of coverage, a desired deductible.

3. The method of claim 2, wherein the type of coverage is selected from the group consisting of life insurance and property insurance for a specified peril.

4. An automated system used by insurance carrier for evaluating insurance risk based on underwriting information comprising
an agent interface;
a database comprising underwriting information and associated underwriting rules established by a carrier; and
an automated system connected to the agent interface and the database through a network;
wherein the automated system receives insurance information from the agent interface, stores the insurance information on the database, retrieves the respective underwriting rules from the database, and processes the insurance information as set out herein.

5. The system of claim 4, wherein the system begins to perform an analysis of insurance risk upon receipt of underwriting information input by an agent through an automated, web-based agent interface.

6. The system of claim 4, wherein the system performs a risk analysis against underwriting and pricing rules, wherein, in response to the system analysis, a premium quotation is issued or a denial of coverage is issued, based on the automated system's risk assessment.

7. The system of claim 6, wherein the system transmits the premium quotation to the agent interface for display to an agent.

8. The system of claim 4, wherein the system subsequently receives an acceptance of the premium quotation via the agent interface.

9. The system of claim 4, wherein, in response to an automated determination by the system that a premium quotation may not be issued for any of several reasons related to the underwriting rules, the system forwards the underwriting information to an automated, task based work flow process that prompts an underwriter for review.

10. The system of claim 9 wherein the system allows the underwriter to analyze the underwriting information and to communicate, if necessary, on a real time basis with the agent to gather additional information to determine the optimal price for a policy.

11. The system of claim 10 wherein the system allows the underwriter to escalate a review of submitted risks to at least one decision maker based on a set of controls whereby any user may not exceed his authority in regard to the risk evaluation process, to determine the optimal price for a policy or whether to deny coverage.

12. The system of claim 9, wherein, in response to a determination by the underwriter, the system sets an optimal premium through use of the task based work flow process and issues a premium quotation to the agent based on the optimal premium.

13. The system of claim 12, wherein the automated system may receive an acceptance of the premium quotation and issues a binder based on the premium quotation.

14. The method of claim 6, further determining that a denial of coverage is appropriate, transmits the information to the agent interface for display to an agent.
